(19) United States
(12) Patent Application Publication
(10) Pub. No.: US 2005/0066162 A1
(43) Pub. Date: Mar. 24, 2005

(54) Method and system for internet entrance security identification and IC card verification hardware device

(76) Inventor: Hui Lin, Taipei (TW)

Correspondence Address: PRO-TECHTOR INTERNATIONAL, 20775 Norada Court, Saratoga, CA, 95070-3018, US

(21) Appl. No.: 10/937,236

(22) Filed: Sep. 8, 2004

(30) Foreign Application Priority Data
Sep. 19, 2003 (TW) 092125968

(51) Int. Cl. H04L 9/32; G06F 11/30

(52) U.S. Cl. 713/155; 713/182; 713/201

(57) ABSTRACT

The prevent invention discloses a method and system for Internet entrance security identification and IC card verification hardware device, and particularly an Integrated Circuit (IC) card identification hardware device of confirming login user's authentication. IC card device and its built-in codes, which can not be duplicated, installed in computer via hardware with USB, PS2, wireless, or IR interface is used as identification hardware to set with Application Server (AP Server). Using non-duplication code in IC card and encryption system of the present invention ensures user authentication and data confidentiality on Internet or any other information system of computer. As using normal private key, the present invention is easy and convenient to use.

### SUMMARY OF THE INVENTION

The present invention relates to a method and system for Internet entrance security identification and IC card verification hardware device which comprises of an IC card and an IC card reading apparatus. The IC card memorizes an identification code (ICCID) and international verification code (GLN). This IC card reading apparatus is conjugated to PC easily by USB interface or PS2 plug or by hardware having wireless or infrared transferring protocol. Owing to the easy set up of this IC card reading device, it can be applied extensively. This IC card and IC card reading apparatus as the verification hardware can also be used as data storage device, and data can be stored not only on hard disk but also on this mobile IC verification hardware device. It makes data reading and depositing more secret, mobile and safer. This IC verification hardware device is further applied to all PC peripheral hardware. This verification hardware device serves as a key to access the computer. It is more acceptable for the computer user. Because the procedure of other verification technology products are complicate, it is un-convenient for the user to handle and leads to giving up using those verification system and further repeals Internet transaction.

FIG. 3 is a symbol view of a preferred embodiment of the present invention.

### FIELD OF THE INVENTION

The present invention relates to a method and system for Internet entrance security identification and IC card verification hardware device more particularly, the invention relates to a system and method that use a verification hardware device as Internet entrance security identification.

### BACKGROUND OF THE INVENTION

### DESCRIPTION OF RELATED ART

In general, Internet security system and method is a process of cryptographing information in the web server to prevent info disclosing. Many computer programs and logic have been designed to cryptograph information and to fight against the hacker, however those programs can't yet prevent from the hacker attack completely.

The user login system is to qualify the user's entrance of a website. To date the users have to sign in ID and passwords of the website to enter. If both are correct, the user can access the main page of the website. This simple system raises a risk that anyone else has both of the ID and password can easily enter the user's main page, and can also query the secret information and record of the user. Considering of the cryptographing technique of the Application Server (AP Server) nowadays, it still have chance to allow the hacker to break the code. In the global village century, Internet communications shorten the distance of the real world. User can access Internet anytime at any place of the world by different computers or other communication device. Users can go on line by computers in the library, coffee shop etc . . . .

As the difficulty of setting authority and staging of nowadays' technique, those secret information can be easily acquired by the next user when the former user forget to logout or by hackers who break the system and further use those personal secret information to perform illegal trade, and those result in the loss of the users.

Current Internet security system is leaky in many aspects as mentioned below.
1. Hackers break the user's code by Dictionary Attack, and imitate as the user
2. Hackers intercept the crude information during TCP/IP protocol and then massage the information.
3. Intercept transporting data on the LAN
   Hackers Break the User's Code by Dictionary Attack, and Imitate as the User

It's the easiest and most dangerous way to login with user's ID and password. The reasons are listed as followed:
1. Most people choose their password based on easiness to remember. Few people would choose a password with letters and numerals in random combination. The famous cryptology master “Daniel Klein” declared that 40% of the user's password can be broken easily by means of “Dictionary Attack”. At the present time, it's scattered with various computer programs performing decoding project designed by students and system experts and hackers in the world of Internet. Those are tools for cracker to invade.
2. Currently, the information system is getting more and more complex. Different password is needed when entering different operating system. Few people can memorize more than three distinct passwords with eight characters. This leads to most people would write down those passwords and put them in a safe and convenient place. Obviously it provides an additional channel for cracker to invade.
3. Even if the clients haven't made those above-mentioned mistakes, it still has a chance for cracker to invade. The password is in a form of plaintext before transferring to the AP Server. Hackers can intercept the password in the route of transferring and then imitate as the user invading the system. Many people have a perception that it can prevent from cracker invasion by simply renting a dedicated line. It's wrong because of the data in the dedicated line is exchanged through public exchange circuit. Once the dedicated line is established, the data-transferring route is fixed. The hacker can concentrate in intercepting data on the fixed route.
   Hackers Intercept the Crude Information During TCP/IP Protocol and then Massage the Information.

The Internet communication protocol is TCP/IP. Before data transferring between two computers, those two computers have to finish three-way Handing Shaking. It's a good opportunity for crackers to invade during this period of time.

The data transferring between two computers is through the public Internet. Since those data being transferred is in the form of plaintext, this give rise to the problem that each computer on the Internet can sniff information therein.

In some cases, the cracker wants to grasp all information of the invaded computer, and then imitate as the user. Not only do they the have privilege of the user but also they can send a large amount of useless information back to the user's computer to collapse it's system Even worse the cracker can doctor up the user's data or release malignant signals, in this situation the blame is imputed on the guiltless user.

If the user goes on line by computer for public use, the computer connects to Internet by LAN (Local Area Network). Within LAN, all output information is in the form of broadcasting, and each computer within the LAN can receive and sniff this information.

Even worse, once the password is cracked, the system could be signed in illegally, and something unauthorized could occur, such as changing data, spreading fake messages, stealing or deleting information for commercial or noncommercial reasons . . . etc.

For the above problems, the leak of Internet security should be mended. To overcome the problems and defects in the prior art described above, one identity confirmation process should be set for double check except for only password.

### BRIEF DESCRIPTION OF THE DRAWINGS

FIG. 1 is a diagram illustrating the operation procedure of the present invention;

FIG. 2 is a diagram showing apparatuses that IC card device of the present invention can couple with;

FIG. 3 is a diagram illustrating the login process of the present invention;

FIG. 4 is a diagram showing embodiment of the IC card device of the present invention;

FIG. 5 is a diagram showing embodiment of the present invention's IC card device in PCMCIA interface apparatus;

FIG. 6 is a diagram showing alternative embodiment of the present invention's IC card device integrated with flash memory;

FIG. 7 is a diagram illustrating the present invention's IC card device integrated with flash memory plugged into computer chassis.

### DETAILED DESCRIPTION OF THE PREFERRED EMBODIMENTS

The technical character of the present invention is to create an IC card which memorized a identification code (ICCID) and a international verification code (GLN). The IC card is put into IC card reading apparatus (reader). This IC reading apparatus is conjugated to PC easily by USB interface or PS2 plug or by hardware with wireless infrared transferring protocol. This IC card and IC card reading apparatus serve as verification hardware. Users have to key in username and password when they get into Internet. The message is processed through program embedded inside IC card and further delivered to Certification Authority (CA) server to be enciphered or deciphered and then ICCID number is obtained. This ICCID number is further confirmed in the CA database. If the ICCID number is correct, then a Random number and KI number are given. This very KI number is the CA Server Result and can be used as record of login frequency, authorities' range, and user validation.

After the first step of IC card verification, verification program of the common AP Server will receive ICCID number, Client Result of the IC card, user name, and password.

The Random number generated from CA server is transmitted back to IC card. Again, through the program embedded inside IC card, the Random number and ICCID are enciphered into Client Result. The client result, user name, and password are transferred to AP Sever. AP Server checks the user name and password first in it's own database and then check useful-life of the user. If the above procedure is passed, the information is transferred from AP Server to CA server to check ICCID number and the Client Result next.

ICCID is decoded in a specific method and match it's correspondence code in CA server. If the correspondent code is found in CA server, the client result is valid in CA server.

If the first step of verification is passed, the AP Server verification program will receive the ICCID number and the Client result within the IC card and the Username and the password that user key in, at the mean while the AP Server will check if the user name and the password are right in it's own database, and also check if the user's useful-life is overdue. If the above procedure is passed, the information is transferred from AP Server to CA server to check ICCID number and the Client Result again. The CA server will decode the value of the ICCID number in a specific signal flow and also check the value in it's own verification database, to find the correspondent cipher of the ICCID number to verify with said validated server result. If the server result matches with the client result, the second step of verification is passed Only after the double check of the user's identity in AP Server and CA server and without doubt can the user enter the login window and the user can go into the web page and the server result is emptied to allow the next login. If not matched, CA sever will send back a failed message to AP Server to reject access.

In the following description, refers to the drawings.

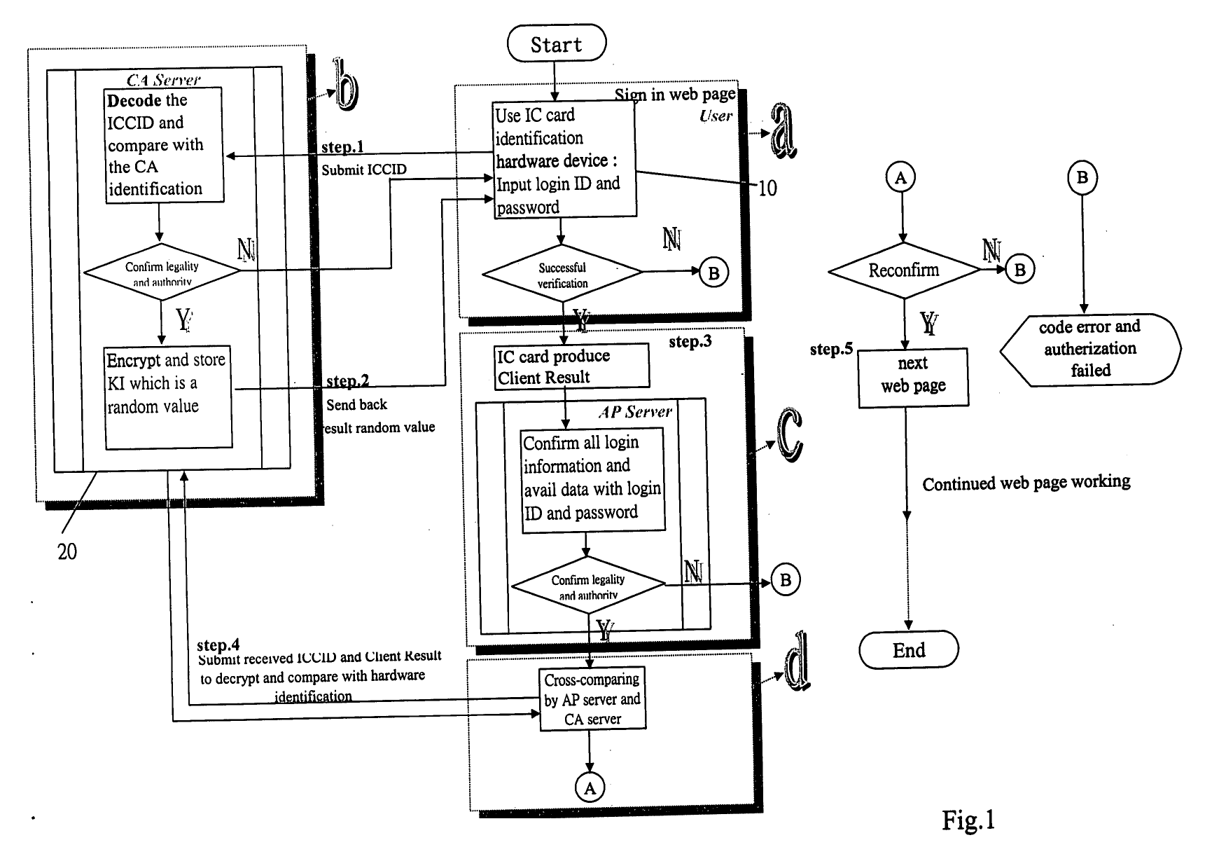

FIG. 1 illustrates procedures of flow sheet of this invention, comprises a, b, c, d four main processes and procedures from step 1 to step 5 of legal login process.
Process a: Use IC card identification hardware device comprising an IC card and its reader to login AP Server. Input login ID and password, then submit.
Process b: IC card transfers login process and ICCID to CA server (step 1). CA server will decode ICCID and compare with its database, confirm legality and authority of ICCID. If it's confirmed, CA server will record in its database and calculate a Server Result, which is a random value, then report this value to IC card (step 2).
Process c: When process b is confirmed, IC card will calculate with random value from CA server and ICCID to a Client Result (step 3), transfer process, ICCID, and Client Result to AP Server. With login ID and password, AP Server will confirm all login information and avail date.
Process d: When process c is confirmed, AP Server will submit received ICCID and Client Result to CA server to decrypt and compare with hardware identification (step 4).

For further description below, in process a, user inserts an IC card having built-in ICCID and GLN code, into a card reader apparatus, which is conjugated to PC easily by USB interface or PS2 plug or by hardware having wireless or infrared as identification hardware device. Using this hardware device to open login process of AP Server and then submit login ID and password.

In process b, when user submits ID and password, program embedded inside IC card will transfer ICCID code to CA server. CA server will decode the ICCID, compare with the CA identification database, produce an authorized (Validate=Y) EKI value, then decode the value to a KI value and calculate a random value, encrypt and store KI as the hardware identification's successful verification (Server Result). This result can also record the accesses of a user, confirm legitimacy and limits of authority of login AP Server of ICCID. When hardware satisfies identification, CA server will send result random value to IC card as a key value. If an IC card fails in cross comparing of authorization (Validate=N), user will be told by system that login fails.

If pass process b, then go to process c. AP Server will receive key value and ICCID code of IC card, and submitted login information, then confirm the information and avail date.

In process d, when process c confirmed, AP Server will send received key and ICCID code to CA server for further confirming. CA server will first decode ICCID, and compare with its database. If this ICCID has a relative valid EKI, use the key value to decode EKI to compare with Server Result. If matched, user can login AP Server, a web page for example, and CA server will clean out its Server Result for next use. If not matched, CA server will tell AP Server ICCID code is in error and authorization fails.

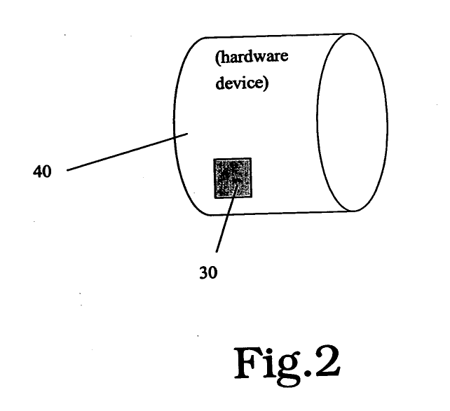

FIG. 2 illustrates exemplary hardware device that could be used to implement the present invention. IC card 30 is burned as firmware into chip. It's hard to fake and copy. Identification hardware 40 is the IC card 30 reader apparatus, which can be hardware compatible to USB, PS2 interface, wireless communication device, or storage medium such as flash memory.

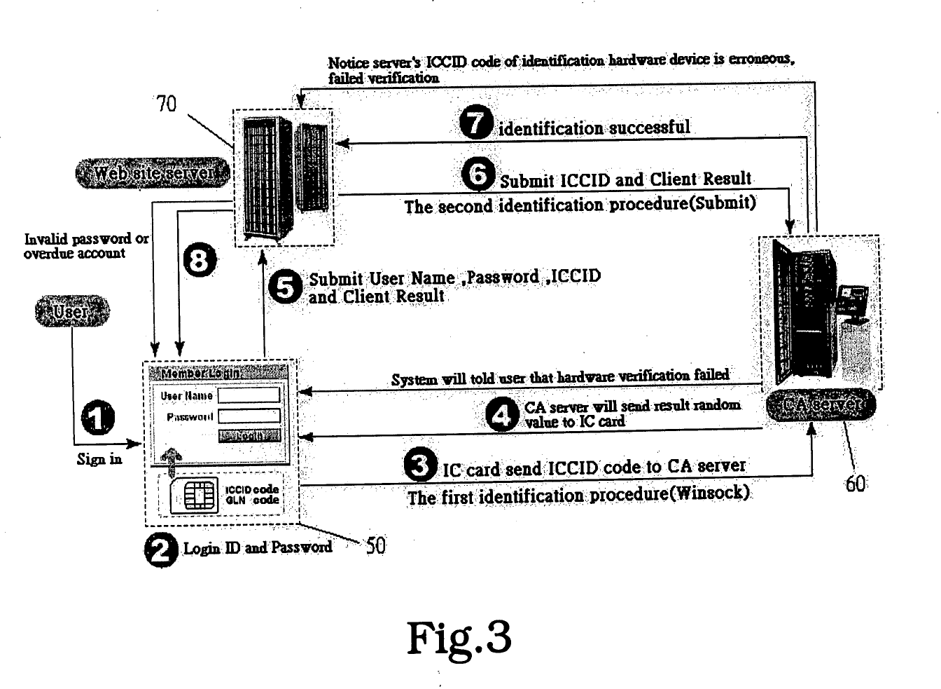

FIG. 3 illustrates substantiality of the present invention. The actual login operation procedure, from submitting to authorization, contains totally 8 routes. Route 1 indicates a user using identification hardware (with IC card) 50 installed in client computer to login web server 70. In route 2 a user submit login ID and password in login window (can be a web page). This will act on route 3, which IC card built-in program will guide login procedure to CA server 60. Route 3 is the first identification procedure (Winsock) of the prevent invention. In this process CA server 60 will compare ICCID code and calculate a Server Result. When hardware identification is confirmed, it will lead route 4. In route 4 when IC card receive random value produced from CA server 60, it will calculate and encrypt to a Client Result. This Client Result will be used to compare for AP Server in second certification procedure.

When first certification procedure succeeds, then it will go to route 5. Web server 70 will receive ICCID code, Client Result, and username and password submitted by user who login. If submitted data is correct, route 6, which is proceeding with second certification procedure, will send ICCID code and Client Result back to CA server 60 to confirm with Server Result. If pass, route 7 will go in CA server 60 to tell web server 70 certification confirmed. After double check to make sure user is legal, web server 70 can login to access, and the final route 8 will go to clean up Server Result in CA server 60. If it fails in route 6, web server 70 will receive a message of ICCID error from CA server 60 and deny to be accessed.

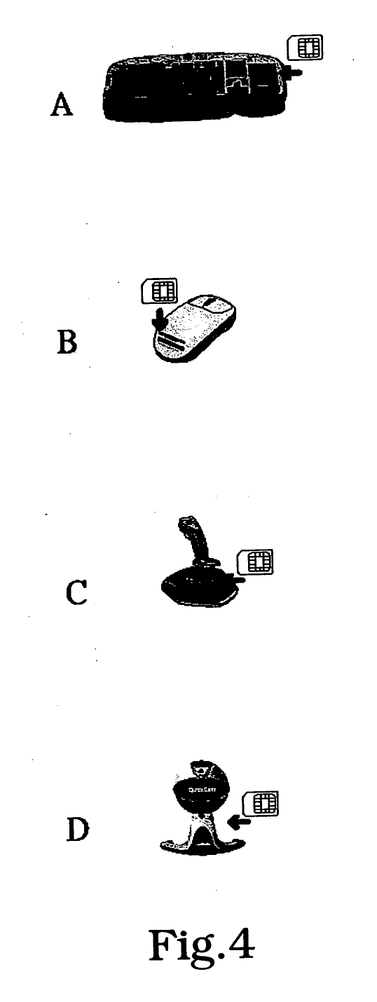

FIG. 4 is a diagram showing exemplary hardware devices for practicing the presenting invention. Besides directly installed in computer via USB, PS2 interface, or wireless, IR hardware device, IC card reader apparatus can also be set within keyboard (A), mouse (B), joystick (C), or even web camera (Web Cam, D) to materialize hardware identification.

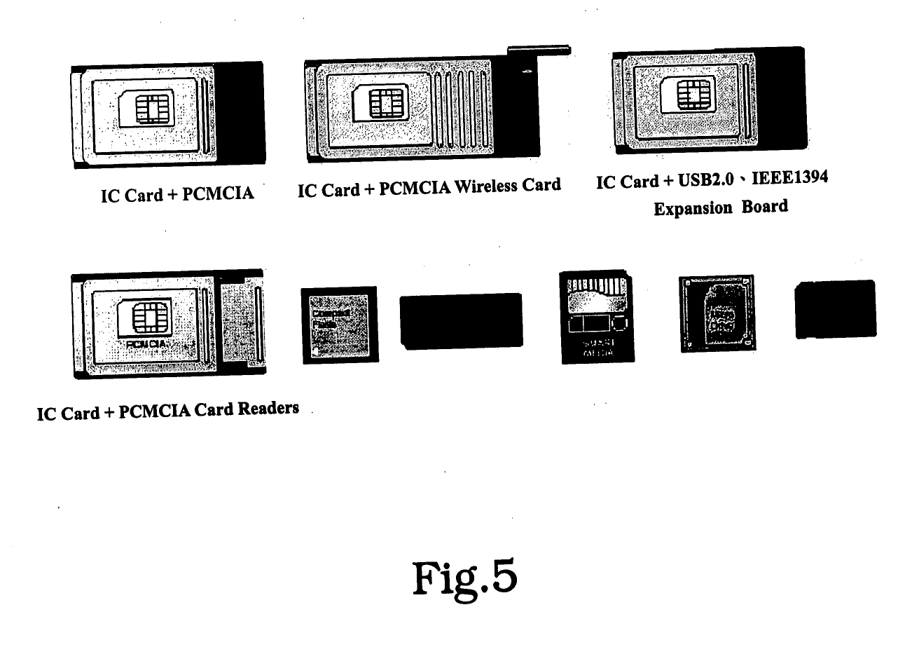

FIG. 5 is a diagram showing IC card reader device set on PCMCIA (Personal Computer Memory Card International Association) interface apparatus, as application of mobile notebook.

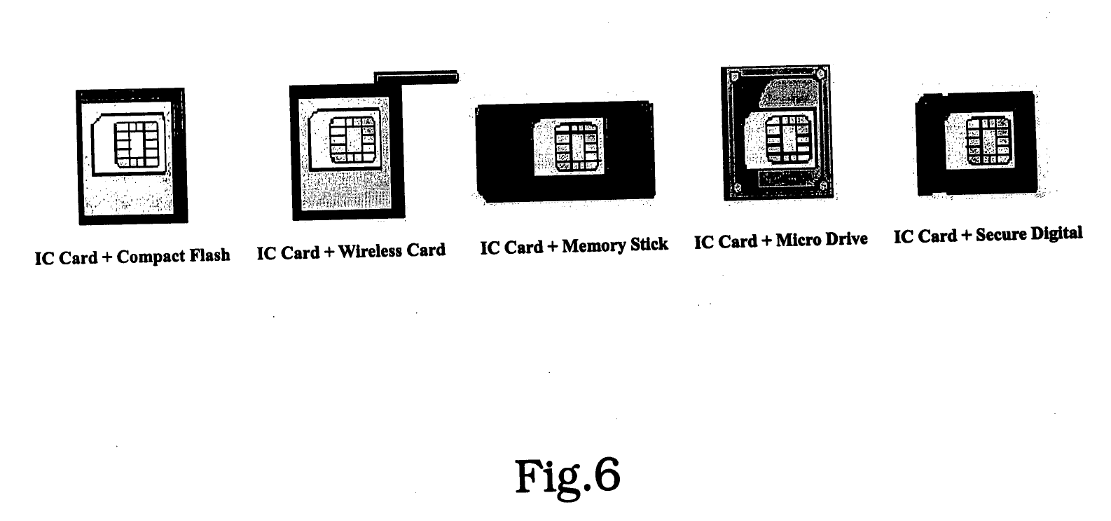

FIG. 6 is a diagram showing IC card device set with flash memory. This combined set can storage and keep also security, mobility, and privacy of data.

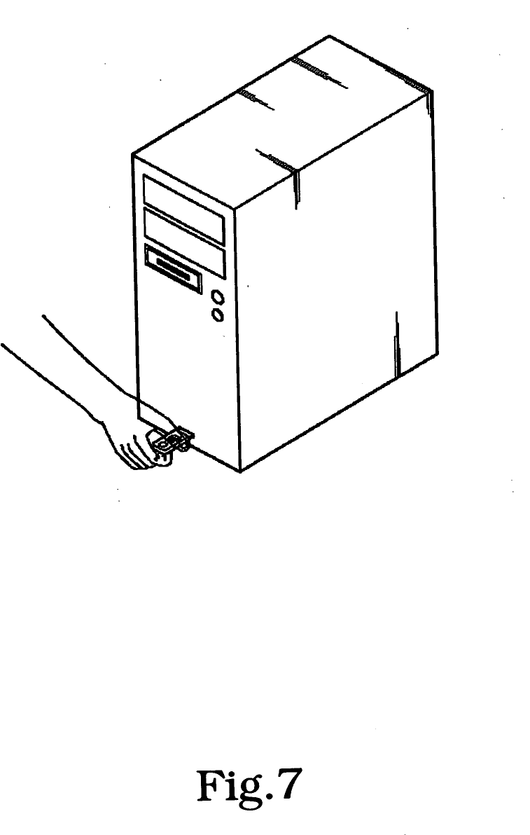

FIG. 7 is foregoing flash memory and IC card device integrated apparatus plugging into computer. Using USB interface device can easily access and work.

The present invention can provide highly standard class security of application (AP) server system on Internet by many encryptions and cross confirming double check system. The IC card identification hardware device can use as a private verification key to access not only on Internet but also many information systems of computer. The foregoing describing of the preferred embodiment of the invention is for the purposes of illustration and description. It is not intended to exhaustive or to limit the invention to the precise from disclosed. Many other possible modifications and variations can be made without departing from the scope of the present invention, which following claims are depended.

1. A method and system for Internet entrance security identification and IC card verification hardware device, using a IC card's built-in ICCID and GLN, and a IC card reader apparatus installed in a computer as identification hardware device, comprising operation processes:
Process a: Use IC card identification hardware device comprising an IC card and its reader to login AP Server. Input login ID and password, then submit;
Process b: IC card transfers login process and ICCID to CA server. CA server will decode ICCID and compare with its database, confirm legality and authority of ICCID. If it's confirmable, CA server will record in its database and calculate a Server Result, which is a random value, then report this value to IC card;
Process c: When process b is confirmed, IC card will calculate with random value from CA server and ICCID to a Client Result, transfer process, ICCID, and Client Result to AP Server. With login ID and password, AP Server will confirm all login information and avail date;
Process d: When process c is confirmed, AP Server will submit received ICCID and Client Result to CA server to decrypt and compare with hardware identification.

2. The method and system for Internet entrance security identification and IC card verification hardware device according to claim 1, wherein the IC card identification hardware device is USB-compliant interface apparatus.

3. The method and system for Internet entrance security identification and IC card verification hardware device according to claim 1, wherein the IC card identification hardware device is PS2-compliant interface apparatus.

4. The method and system for Internet entrance security identification and IC card verification hardware device according to claim 1, wherein the IC card identification hardware device is wireless communicable interface apparatus.

5. The method and system for Internet entrance security identification and IC card verification hardware device according to claim 1, wherein the IC card identification hardware device is IEEE1394-compliant (Institute of Electrical and Electronic Engineers 1394) interface apparatus.

6. The method and system for Internet entrance security identification and IC card verification hardware device according to claim 1, wherein the IC card identification hardware device is IR communicable interface apparatus.

7. The method and system for Internet entrance security identification and IC card verification hardware device according to claim 1, wherein the IC card identification hardware device is flash memory.

8. The method and system for Internet entrance security identification and IC card verification hardware device according to claim 1, wherein the IC card identification hardware device is PCMCIA-compliant interface apparatus.

9. The method and system for Internet entrance security identification and IC card verification hardware device according to claim 1, wherein the IC card identification hardware device is keyboard.

10. The method and system for Internet entrance security identification and IC card verification hardware device according to claim 1, wherein the IC card identification hardware device is mouse.

11. The method and system for Internet entrance security identification and IC card verification hardware device according to claim 1, wherein the IC card identification hardware device is joystick.

12. The method and system for Internet entrance security identification and IC card verification hardware device according to claim 1, wherein the IC card identification hardware device is Web Cam.
